(19) United States
(12) Patent Application Publication
(10) Pub. No.: US 2008/0011496 A1
(43) Pub. Date: Jan. 17, 2008

(54) Tractor-pulled grubber

(76) Inventors: Perry A. Garrison, Bellevue, TX (US); Riley J. Garrison, Bellevue, TX (US)

Correspondence Address: Stephen R. Greiner, Esquire;GREINER LAW OFFICES, P.C., Suite 110, 6701 Democracy Blvd., Bethesda, MD, 20817, US

(21) Appl. No.: 11/484,689

(22) Filed: Jul. 12, 2006

(51) Int. Cl. A01B 63/16

(52) U.S. Cl. 172/398

(57) ABSTRACT

A tractor-pulled grubber including a frame for movement over the ground. The frame includes: a blade carrying assembly, a trailer hitch assembly secured to the front of the blade carrying assembly, and a lifting assembly pivotally secured to the rear of the blade carrying assembly. The lifting assembly has a pair of forward legs that are pivotally secured to the rear of the blade carrying assembly and extend downwardly therefrom. The lifting assembly also includes a pair of rearward legs, each of which is affixed to a respective one of the forward legs and extends downwardly and rearwardly therefrom. A tie bar rigidly connects the rearward legs together. A pair of forward wheels is rotatably secured to the forward legs. A pair of rearward wheels is rotatably secured to the rearward legs. An earth penetrating blade assembly is suspended from the blade carrying assembly for plowing the ground. A hydraulic cylinder connects the blade carrying assembly to the lifting assembly for pivoting the lifting assembly between a first state wherein the forward wheels are in contact the ground and the rearward wheels are in disengagement with the ground and a second state wherein the forward wheels are in disengagement with the ground and the rearward wheels are in contact with the ground.

### FIELD OF THE INVENTION

The present invention relates generally to earth working apparatus and, more particularly, to such an apparatus with an actuator on a trailing, ground-supported frame for moving draft means laterally and/or vertically.

### BACKGROUND OF THE INVENTION

It is common to employ mechanical treatments to remove invasive weeds, shrubs, and trees that impede the use of land. The effectiveness of such treatments depends upon many factors including: the equipment selected and the method of its use, the targeted plants and their sprouting characteristics, soil type, topography, and climate. Fortunately, mechanical treatments are usually effective and can be the only reasonable choice when herbicides cannot be used.

Grubbing is an excellent mechanical treatment for selectively thinning brush-invaded lands. Careful grubbing can provide a given piece of land with both sculpted, wildlife habitats and cleared, grazing areas. Grubbing is not practical, however, on lands with rocky soils or those with high densities of trees. Nevertheless, grubbing can kill 90 percent or more of many types of plants at costs of only a few dollars per acre.

Grubbers are sharp, U-shaped blades that are normally mounted upon lifting arms provided to the fronts of many track loaders and farm tractors. On the lifting arms, grubbers can be hydraulically raised and lowered to assist in the severing of plant trunks and the tearing of plant roots. A few grubbers are commercially available, but most are custom-made in welding shops for mounting upon a particular set of lifting arms and for using in a particular environment. Thus, grubbers can be time-consuming and costly to manufacture.

### SUMMARY OF THE INVENTION

In light of the problems associated with the known grubbers that are mounted upon lifting arms that not all farm vehicles are provided with, it is a principal object of the invention to provide a grubber that can be universally attached to a towing vehicle, such as a farm tractor that is commonly equipped with a trailer hitch, and that can be easily operated by the driver of the towing vehicle while the towing vehicle is in motion.

Still another object of the invention is to provide a grubber of the type described that can be selectively elevated to vary the height at which plant roots are torn from the ground or that tree trunks are severed.

It is a further object of the invention to provide a grubber of the type described that can traverse both rough terrain without bogging down and smooth roadways without causing roadway damage.

It is another object of the invention to provide a grubber of the type described that is relatively compact in size and that can be easily maneuvered around structures where conventional grubbers are ineffective.

It is a further object of the invention to provide a grubber of the type described that permits a user to work from a vantage point ahead of the grubber, optimizing his field of vision, so that the grubber can be steered with maximum speed to plants for uprooting.

It is an object of the invention to provide improved features and arrangements thereof in a tractor-pulled grubber for the purposes described that is inexpensive to manufacture and dependable in use.

Briefly, the grubber in accordance with this invention achieves the intended objects by featuring an articulated frame for movement over the ground. The frame includes a blade carrying assembly having a forward portion and a rearward portion that are pivotally connected. The frame also includes a trailer hitch assembly secured to the front of the forward portion and a lifting assembly that is secured to the rearward portion. The lifting assembly has a pair of forward legs that are pivotally secured to the rear of the rearward portion and extend downwardly therefrom and a pair of rearward legs, each of which is affixed to a respective one of the forward legs and extends downwardly and rearwardly therefrom. A tie bar rigidly connects the rearward legs together. A pair of forward wheels is rotatably secured to each of the forward legs, and each of the forward wheels has a metallic drum for rolling upon the ground. A pair of rearward wheels is rotatably secured to each of the rearward legs, and each of the rearward wheels has a rubber tire for rolling upon the ground. An earth penetrating blade assembly is suspended from the forward portion for plowing the ground. A first hydraulic cylinder connects the top of a boom, at the rear of the rearward portion, to the lifting assembly for pivoting the lifting assembly between a first state wherein the forward wheels are in contact the ground and the rearward wheels are in disengagement with the ground and a second state wherein the forward wheels are in disengagement with the ground and the rearward wheels are in contact with the ground. A second hydraulic cylinder connects the forward portion to the rearward portion for pivoting the rearward portion relative to the forward portion.

The foregoing and other objects, features, and advantages of the present invention will become readily apparent upon further review of the following detailed description of the preferred embodiment as illustrated in the accompanying drawings.

### BRIEF DESCRIPTION OF THE DRAWINGS

The present invention may be more readily described with reference to the accompanying drawings, in which:

FIG. 1 is a perspective view of a tractor-pulled grubber in accordance with the present invention.

FIG. 2 is a front view of the tractor-pulled grubber of FIG. 1.

FIG. 3 is a side view of the tractor-pulled grubber.

FIG. 4 is a side view of the tractor-pulled grubber with portions broken away and with the forward and rearward wheels thereof alternately contacting the ground to selectively elevate the plow blade assembly thereof.

FIG. 5 is a rear view of the tractor-pulled grubber.

FIG. 6 is a top view of the tractor-pulled grubber.

FIG. 7 is a schematic diagram showing the hydraulic control system of the tractor-pulled grubber

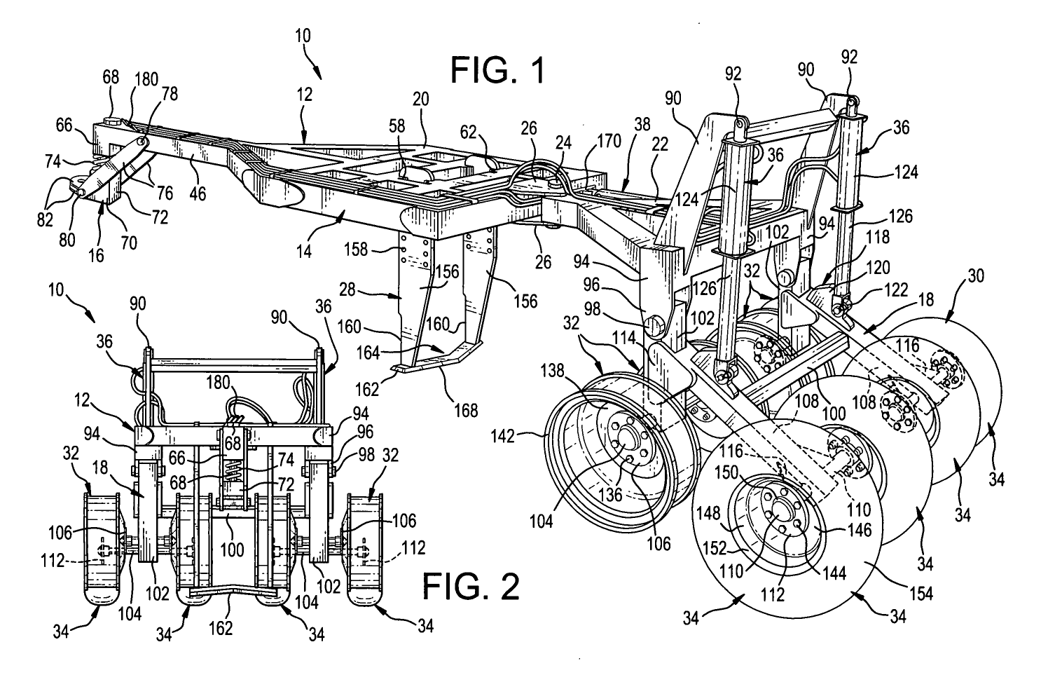

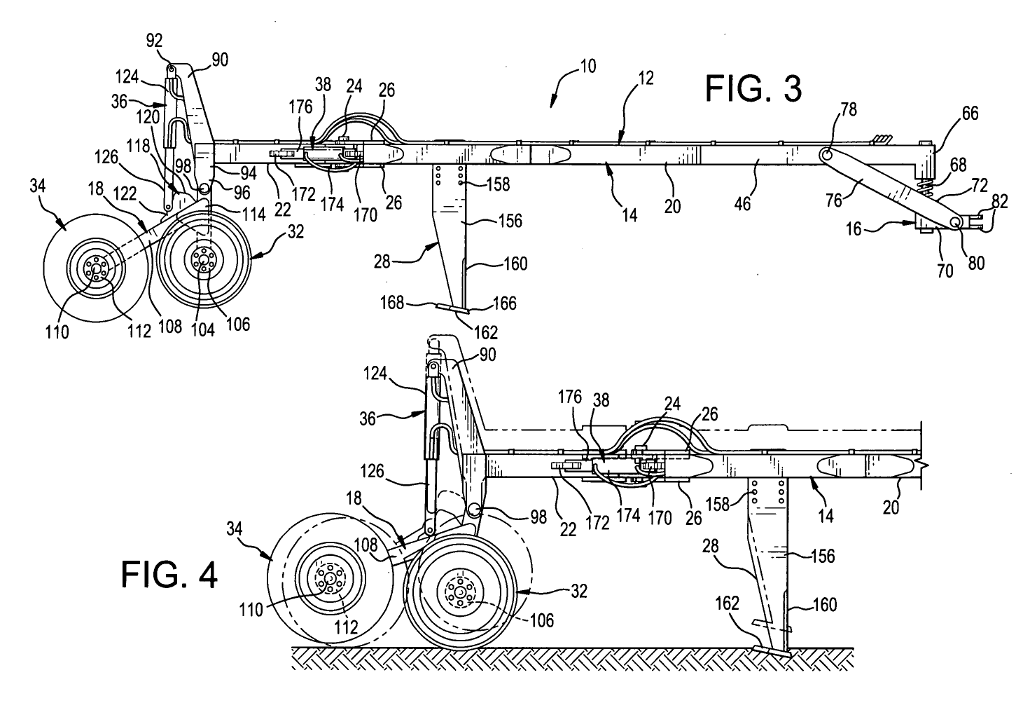

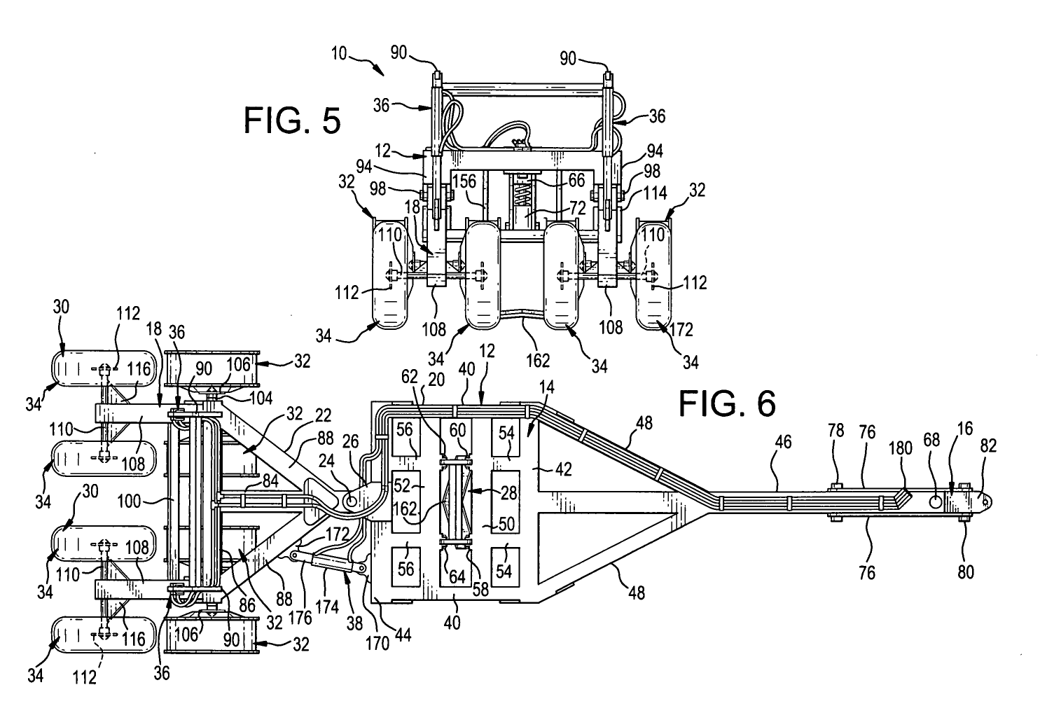

Similar reference characters denote corresponding features consistently throughout the accompanying drawings.

### DETAILED DESCRIPTION OF THE PREFERRED EMBODIMENT

Referring now to the FIGS., a tractor-pulled grubber in accordance with the present invention is shown at 10. Grubber 10 includes an articulated frame 12 having a blade carrying assembly 14 with a trailer hitch assembly 16 secured to its front and a lifting assembly 18 secured to its rear. Blade carrying assembly 14 has a forward portion 20 and a rearward portion 22 being connected together by a pivot pin 24. Forward portion 20 has trailer hitch assembly 16 at its front for connection to a tractor and a pair of hinge plates 26 at its rear for receiving pivot pin 24. At the middle of forward portion 20 is secured an earth-penetrating blade assembly 28. Lifting assembly 18, however, has a pair of ground-engaging trucks 30 secured to the rear of portion 22. Each of trucks 30 has a pair of forward wheels 32 at its front for engagement with soil and a pair of rearward wheels 34 at its rear for engagement with roadways. By means of a pair of hydraulic cylinders 36, trucks 30 can be pivoted forwardly or rearwardly to place either wheels 32 or 34 on the ground. By means of a second hydraulic cylinder 38, rearward portion 22 can be pivoted relative to forward portion 20 so as to steer grubber 10 from side to side.

Forward portion 20 has a pair of side rails 40 that are connected together at their front ends by a forward crossbar 42 and at their rear ends by a medial crossbar 44. The rear end of a towbar 46 is affixed to the middle of crossbar 42. Towbar 46 is reinforced by a pair of forward struts 48, each of which is affixed, at its rear end, to the front of a respective one of side rails 40 and is affixed, at its front end, to a respective one of the sides of towbar 46 about midway between the front and rear ends of towbar 46. A pair of cross braces 50 and 52 connect side rails 40 at spaced-apart locations between crossbars 42 and 44. Cross brace 50 is reinforced by a pair of spaced-apart brace blocks 54 that extend forwardly therefrom to crossbar 42. Cross brace 44 is similarly reinforced by a pair of spaced-apart brace blocks 56 that extend rearwardly from cross brace 52 to crossbar 44.

A pair of clamps 58 is affixed to cross brace 50 for releasably securing blade assembly 28 to frame 12. Each of clamps 58 is a pair of L-shaped members positioned against the rearward surface of cross brace 50 and spaced from one another so as to define a slot therebetween. The rearwardly extending leg of each L-shaped member is apertured so as to receive a pair of threaded fasteners 60. When tightened, fasteners 60 draw the rearwardly extending legs of the L-shaped members together to tightly grasp the front of blade assembly 28.

A pair of clamps 62 is affixed to cross brace 52 in axial alignment with clamps 62 for releasably securing blade assembly 28 to frame 12. Each of clamps 62 is a pair of L-shaped members positioned against the forward surface of cross brace 52 and spaced from one another so as to define a slot therebetween. The forwardly extending leg of each L-shaped member is apertured so as to receive a pair of threaded fasteners 64. When tightened, fasteners 64 draw the forwardly extending legs of the L-shaped members together to tightly grasp the rear of blade assembly 28.

A pair of hinge plates 26 is affixed to the middle of medial crossbar 44 and extends rearwardly therefrom. As shown, hinge plates 26 are vertically aligned, with one of plates 26 being positioned against the top of crossbar 44 and the other being positioned against the bottom of crossbar 44. An aperture (not shown) in the rear end of each of hinge plates 26 snugly receives the vertically oriented, pivot pin 24.

Forward portion 20 is provided with a shock-absorbing, trailer hitch assembly 16 for connecting grubber 10 to a tractor. Hitch assembly 16 includes an upper, spring-receiving cup 66 that is affixed to both the front end and bottom surface of towbar 46. A guide rod 68 is also affixed to the front end of towbar 46 and extends downwardly from the center of cup 66. Slidably positioned on the bottom of guide rod 68 is a hitch bar 70. Affixed to the top of hitch bar 70, so as to surround guide rod 68, is a lower, spring-receiving cup 72. Disposed between cups 66 and 72 is a compressed, coiled spring 74 that normally urges towbar 46 and hitch bar 70 away from one another and absorbs shocks. A pair of pivot arms 76, one positioned on each side of towbar 46, reinforces the connection between towbar 46 and hitch bar 70 and conduct pulling forces past guide rod 68. Arms 76 are connected at their rear ends by a pivot rod 78 to towbar 46 rearwardly of cup 66 and are connected at their front ends by a pivot rod 80 to hitch bar 70 forwardly of cup 72. Forwardly of pivot rod 80, hitch bar 70 is provided with a pair of vertically aligned, apertured, hitch plates 82, for connection, by means of a hitch pin (not shown), to the trailer hitch of a tractor.

Rearward portion 22 includes lifting assembly 18 having a drag bar 84 with an apertured front end adapted to receive pin 24 for a pivoting connection to, and between, hinge plates 26 of forward portion 20. The rear end of drag bar 84 is affixed to the middle of a rear crossbar 86. Drag bar 84 is reinforced by a pair of rearward struts 88, each of which is affixed, at its rear end, to a respective one of the opposed sides of crossbar 86 and is affixed, at its front end, to a respective one of the opposite sides of drag bar 84 proximate the front end of drag bar 84. A pair of booms 90, one at each end of crossbar 86, is affixed to crossbar 86 and extend upwardly and rearwardly therefrom. Each of booms 90 is apertured at its top for receiving a pivot pin 92 that pivotally connects a respective one of a pair of hydraulic cylinders 36 thereto. A pair of snubbing posts 94, one at each end of crossbar 86, is also affixed to crossbar 86 and extend downwardly therefrom. Each post 94 carries, at its bottom end, a pair of laterally spaced, apertured pivot plates 96 for receiving a pivot pin 98 that pivotally connects lifting assembly 18 to carrying assembly 14.

Lifting assembly 18 includes a pair of trucks 30 connected together by a tie bar 100. Each truck 30 has a forward leg 102 whose top is positioned between pivot plates 96 and is penetrated by pivot pin 98 for a pivotal connection to respective one of posts 94. A forward axle 104 passes laterally through each forward leg 102 and is affixed thereto. A pair of forward hubs 106 is rotatably fastened to each forward axle 104 with a respective one of hubs 106 being fastened to each end thereof. Each truck 30 also has a rearward leg 108 that is affixed, at its top, to the top of forward leg 102 and extends downwardly and rearwardly therefrom. A rearward axle 110 passes laterally through each rearward leg 108 and is affixed thereto. A pair of rearward hubs 112 is rotatably fastened to each rearward axle 110 with a respective one of hubs 112 being fastened to each end thereof.

Lifting assembly 18 is reinforced for maximum strength. One pair of gussets 114 is provided to each truck 30, with one being located on each side of a leg 102, to buttress the connection of leg 102 to leg 108. Another pair of gussets 116 is provided to each truck 30, with one being located on each side of leg 108, to strengthen the connection between leg 108 and rearward axle 110.

One of a pair of hydraulic cylinder anchors 118 is affixed to the top of each rearward leg 108 between gussets 114. Each anchor 118 has an elevated, stop section 120 positioned closely adjacent forward leg 102 and an apertured attachment section 122 of diminished height positioned remote from forward leg 102. Stop section 120 can engage crossbar 86 to prevent the over-rotation of lifting assembly 18, and damage to hydraulic cylinders 36 in the event of an unintended loss of hydraulic fluid in hydraulic cylinders 36.

One of a pair of hydraulic cylinders 36 is secured to each truck 30 for pivoting lifting assembly 18 relative to carrying assembly 14. As shown, each cylinder 36 includes a hollow body 124 that is pivotally secured at its top to a respective one of booms 90. Each cylinder 36 also includes a piston 126 that can be selectively extended from body 124. The bottom of each piston 126 is pivotally secured to the attachment section 122 of a respective one of anchors 118.

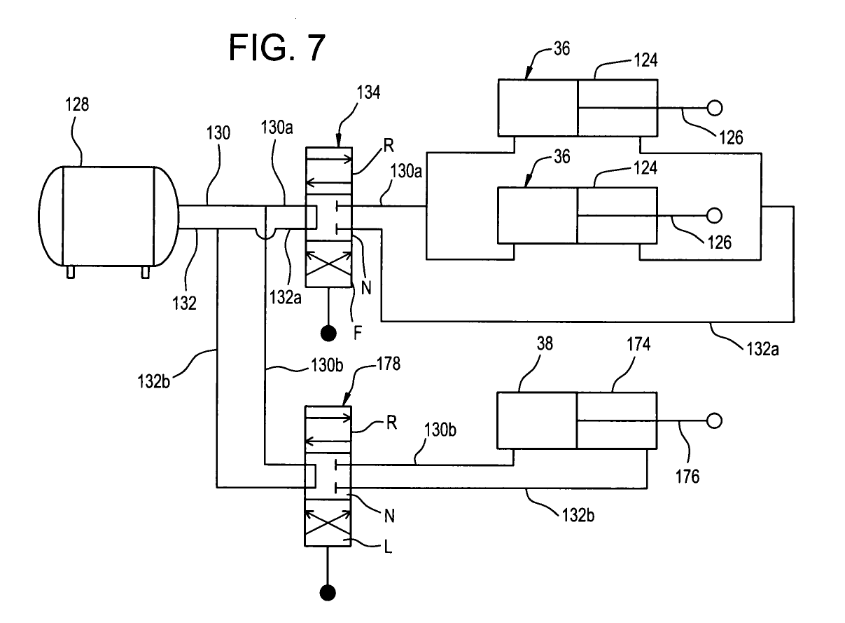

The flow of hydraulic fluid into cylinders 36 controls the movement of lifting assembly 18 relative to carrying assembly 14. As shown in FIG. 7, hydraulic fluid is delivered from a vehicle-mounted pump 128 to hydraulic cylinders 36 through a discharge conduit 130 that terminates at a branch 130a. Hydraulic fluid returns to pump 128 through a suction conduit 132 that begins with a branch 132a.

Discharge conduit branch 130a is provided with a tractor-mounted, manually operated valve 134 that controls the flow of hydraulic fluid to cylinders 36. Valve 134 is situated so that its segment N is engaged with conduit branch 130a whereby hydraulic fluid flows to and from valve 134 into suction conduit branch 132a without moving extensible pistons 126 within bodies 124 so that such remain at rest or in neutral. Should valve 134 be shifted so that its R segment is engaged with conduit branch 130a, hydraulic fluid is permitted to flow to the tops of cylinders 36 to drive pistons 126 from the cylinders to rotate rearward wheels 34 into downwardly and forwardly engagement with the ground. If, however, valve 134 is shifted so that its F segment is engaged with conduit branch 130a, hydraulic fluid is permitted to flow to the bottoms of cylinders 36 thereby retracting pistons 126 and rotating forward wheels 32 downwardly and rearwardly into engagement with the ground. Between the limits of their motion, it should be appreciated that the positions of wheels 32 and 34 can be infinitely varied.

A forward wheel 32 is connected by means of threaded fasteners 136 to each of forward hubs 106 so that each truck 30 is provided with a pair of wheels 32. Each wheel 32 includes a circular sidewall 138 to the periphery of which a cylindrical drum 140 is affixed. Sidewall 138 is provided with a central opening 142 for receiving the outer end of axle 104 and a number of smaller, secondary openings (not shown) that orbit opening 142 for the passage of threaded fasteners 136. Drum 140, however, is reinforced at its inner and outer edges by elevated bands 142 that also serve to permit grubber 10 to be steered on loose soil by penetrating the soil and minimizing sideslip.

A rearward wheel 34 is connected by means of threaded fasteners 144 to each of rearward hubs 112 so that a pair of wheels 34 that follow directly behind wheels 32. Each wheel 34 includes a circular sidewall 146 to the periphery of which a cylindrical drum 148 is affixed. Sidewall 146 is provided with a central opening 150 for receiving the outer end of axle 110 and a number of smaller, secondary openings (not shown) that orbit opening 150 for the passage of threaded fasteners 144. Drum 148 is reinforced at its inner and outer edges by elevated bands 152 that also serve to retain an inflated, rubber tire 154 about the periphery of drum 148 for the smooth engagement with roadways.

Blade assembly 28 is suspended beneath forward portion 20 between cross braces 50 and 52. Blade assembly 28 includes a pair of vertical cutting blades 156 whose top ends are secured by threaded fasteners 60 and 64 to clamps 58 and 62. Vertically aligned bores 158 provided in the top ends of blades 156 permit threaded fasteners 60 and 64 to pass through blades 156 at different heights so that the elevation of blade assembly 28 relative to the ground can be selectively varied. The front edges of blades 156 are sharpened as at 160 for easy passage through the soil and vegetative matter upon and below the top of the soil. The bottom ends of vertical cutting blades 156 are affixed to the opposite ends of a horizontal cutting blade 162. Horizontal cutting blade 162 is V-shaped so as to define a concavity 164 in its sharpened front edge 166 for drawing vegetative matter inwardly for cutting. As shown, blade 162 slopes downwardly toward its front edge so that blade 162 continuously “bites” the soil as it is moved forwardly. The rear edge 168 of blade 162 is also sharpened or tapered in width so as to reposition soil displaced by blade 162 with a minimum of disturbance.

Grubber 10 can be steered as it is moved over the ground. To this end, the right side of crossbar 44 is provided with an apertured, hydraulic cylinder anchor 170 and, adjacent thereto, the right rearward strut 88 is provided with an apertured, hydraulic cylinder anchor 172. The front of a hollow body 174 of a hydraulic cylinder 38 is pivotally secured to anchor 170. The rear end of a piston 176, capable of being extended from body 174, is pivotally secured to anchor 172. By supplying pressurized hydraulic fluid to the front of body 174, and withdrawing fluid from the rear of body 174, piston 176 is extended to pivot rearward portion 22 to the left relative to forward portion 20 thereby turning grubber 10 to the left as such is moved forwardly over the ground. On the other hand, by supplying pressurized hydraulic fluid to the rear of body 174, and withdrawing hydraulic fluid from the front of body 174, piston 176 is retracted into body 174 to pivot rearward portion 22 to the right thereby turning grubber 10 to the right as it is moved over the ground.

Hydraulic fluid is delivered from pump 128 to hydraulic cylinder 38 through discharge conduit 130 and its branch 130b. Discharge conduit branch 130b is provided with a tractor-mounted, manually operated valve 178 that controls the flow of hydraulic fluid to the cylinder 38. Valve 178 is positioned so that its segment N is engaged with branch 130b whereby hydraulic fluid flows to and from valve 178 into suction conduit branch 132b without moving piston 176 within body 174 so that piston 176 remains at rest or in neutral. If valve 178 is shifted so that its R segment is engaged with conduit branch 130b, hydraulic fluid flows to the front of cylinder 38 to drive piston 176 from cylinder 38 to rotate rearward portion 22 relative to forward portion 20 so that grubber 10 shifts to the right as it is being pulled forward over the ground. If valve 178 be shifted so that its L segment is engaged with conduit branch 130b, hydraulic fluid flow to the rear of cylinder 38 thereby retracting piston 176 and moving grubber 10 to the left as it is being pulled over the ground. Between the limits of its motion, the angular orientation of rearward portion 22 relative to forward portion 20 can be infinitely varied for precise steering of the grubber 10 to vegetation requiring grubbing by blade assembly 28.

The use of grubber 10 is straightforward. First, grubber 10 is attached to a towing vehicle by means of hitch assembly 16 in a conventional manner. Then, conduit branches 130a, 130b, 132a, and 132b are connected at fittings 180 to conduits 130 and 132 extending from tractor-mounted pump 128. Now, horizontal blade 162 is adjusted, in terms of its plowing height, by: unscrewing fasteners 60 and 64, repositioning assembly 28 higher or lower in clamps 58 and 62, extending fasteners 60 and 64 through different bores 158 provided for this purpose in vertical blades 156, and retightening fasteners 60 and 64. Afterward, grubber 10 is towed from a storage shed or barn over a paved roadway with rearward wheels 34 in engagement with the roadway so as to not cause damage to the roadway.

Once grubber 10 is positioned upon a piece of land to be cleared of brush, valve 134 is manually manipulated to pivot forward wheels 32 into engagement with the ground and to elevate rearward wheels 34 above the ground. This shortens the wheelbase of grubber 10 for easier turning and also spreads loads that could otherwise cause grubber 10 to become stuck in wet terrain. Grubber 10, then, is towed forward so that blades 156 and 160 cut down small trees, shrubs and other unwanted plants. The alignment of blades 156 and 160 with brush is accomplished by steering the towing vehicle to the brush but is secondarily performed by the manual manipulation of valve 178 so as to draw the rear end of grubber 10, and blades 156 and 160, to the right or to the left. Thus, a user about to miss a significant plant can easily steer grubber 10 to it rather than inefficiently make a second pass at the plant a later time.

While grubber 10 has been described with a high degree of particularity, it will be appreciated by those skilled in the art that modifications can be made to it. For example, it may be possible to pivot lifting assembly 18 relative to carrying assembly 14 by means of a single hydraulic cylinder 36 though a single replacement cylinder would need to be capable of handling greater loads than the pair it replaced. Furthermore, one might connect cylinders 36 directly to crossbar 86 rather than to booms 90 to reduce the construction costs of grubber 10; but, by reducing the angles at which pistons 126 connect to legs 108, the loads on cylinders 36 are greatly increased thereby increasing operating costs. Therefore, it is to be understood that the present invention is not limited to the sole grubber embodiment described above, but encompasses any and all embodiments within the scope of the following claims.

I claim:

1. A tractor-pulled grubber, comprising:
a frame for movement over the ground, said frame including:
a blade carrying assembly;
a trailer hitch assembly being secured to the front of said blade carrying assembly;
a lifting assembly being pivotally secured to the rear of said blade carrying assembly, said lifting assembly including:
a pair of forward legs being pivotally secured, in a side-by-side relationship, to the rear of said blade carrying assembly and extending downwardly from said blade carrying assembly;
a pair of rearward legs, each of said rearward legs being affixed to a respective one of said forward legs and extending downwardly and rearwardly therefrom;
a tie bar rigidly connecting said rearward legs together;
a pair of forward wheels, each of said forward wheels being rotatably secured to a respective one of said forward legs;
a pair of rearward wheels, each of said rearward wheels being rotatably secured to a respective one of said rearward legs;
an earth penetrating blade assembly suspended from said blade penetrating assembly for plowing the ground; and,
a first hydraulic cylinder connecting said blade carrying assembly to said lifting assembly for pivoting said lifting assembly between a first state wherein said forward wheels are in contact the ground and said rearward wheels are in disengagement with the ground and a second state wherein said forward wheels are in disengagement with the ground and said rearward wheels are in contact with the ground.

2. The tractor-pulled grubber according to claim 1 wherein:
each of said forward wheels includes a metallic drum for rolling upon the ground; and,
each of said rearward wheels including a rubber tire for rolling upon the ground.

3. The tractor-pulled grubber according to claim 1 wherein said blade carrying assembly includes a forward portion and a rearward portion being connected together so as to pivot about a vertical axis and said tractor-pulled grubber further comprising a second hydraulic cylinder connecting said forward portion to said rearward portion for pivoting said rearward portion relative to said forward portion.

4. The tractor-pulled grubber according to claim 1 wherein said earth penetrating blade assembly includes:
a pair of vertical cutting blades secured at their respective tops to said blade carrying assembly; and,
a horizontal cutting blade having opposed ends and being affixed at said opposed ends to the respective bottoms of said vertical cutting blades, and said horizontal cutting blade having a concave and sharpened front edge.

5. The tractor-pulled grubber according to claim 1 wherein said trailer hitch assembly further comprises:
an upper, spring-receiving cup being affixed to the bottom of said blade carrying assembly;
a guide rod being affixed to said blade carrying assembly and extending downwardly from the center of said upper, spring-receiving cup;
a hitch bar being slidably positioned on the bottom of said guide rod;
a lower, spring-receiving cup being affixed to the top of said hitch bar so as to surround said guide rod;
a coiled spring being disposed between said blade carrying assembly and said hitch bar and having its top positioned within said upper, spring-receiving cup and its bottom positioned within said lower, spring-receiving cup;
a pair of pivot arms, a respective one of said pivot arms being positioned on each side of said hitch bar, said pivot arms having rear ends that are pivotally connected to blade carrying assembly rearwardly of upper, spring-receiving cup and said pivot arms having front ends that are pivotally connected to said hitch bar forwardly of said lower, spring-receiving cup; and,
a pair of vertically aligned, apertured, hitch plates affixed to the front of said hitch bar.

6. A tractor-pulled grubber, comprising:
an articulated frame for movement over the ground, said frame including:
a blade carrying assembly including:
a forward portion; and,
a rearward portion being connected to said forward portion so as to pivot about a vertical axis, said rearward portion having an upwardly extending boom located at the rear thereof;
a trailer hitch assembly being secured to the front of said forward portion;
a lifting assembly being pivotally secured to the rear of said rearward portion, said lifting assembly including:
a pair of forward legs being pivotally secured to the rear of said rearward portion and extending downwardly from said rearward portion;
a pair of rearward legs, each of said rearward legs being affixed to a respective one of said forward legs and extending downwardly and rearwardly therefrom;
a tie bar rigidly connecting said rearward legs together;
a pair of forward wheels being rotatably secured to each of said forward legs, each of said forward wheels having a metallic drum for rolling upon the ground;
a pair of rearward wheels being rotatably secured each of said rearward legs, each of said rearward wheels having a rubber tire for rolling upon the ground;
an earth penetrating blade assembly suspended from said forward portion for plowing the ground;
a first hydraulic cylinder connecting the top of said boom to said lifting assembly for pivoting said lifting assembly between a first state wherein said forward wheels are in contact the ground and said rearward wheels are in disengagement with the ground and a second state wherein said forward wheels are in disengagement with the ground and said rearward wheels are in contact with the ground; and,
a second hydraulic cylinder connecting said forward portion to said rearward portion for pivoting said rearward portion relative to said forward portion.

7. The tractor-pulled grubber according to claim 6 wherein said earth penetrating blade assembly includes:
a pair of vertical cutting blades secured at their respective tops to said forward portion; and,
a horizontal cutting blade having opposed ends and being affixed at said opposed ends to the respective bottoms of said vertical cutting blades, and said horizontal cutting blade having a concave and sharpened front edge.
